(19) United States
(12) Patent Application Publication
(10) Pub. No.: US 2019/0138428 A1
(43) Pub. Date: May 9, 2019

(54) REGRESSION MANAGEMENT MECHANISM

(71) Applicant: Facebook, Inc., Menlo Park, CA (US)

(72) Inventors: Jiro Sumitomo, San Mateo, CA (US); Marco Junior Salazar, New York, NY (US); Scott Kenneth Yost, Bothell, WA (US)

(21) Appl. No.: 15/806,309

(22) Filed: Nov. 7, 2017

(51) Int. Cl. G06F 11/36; G06F 9/44

(52) U.S. Cl. CPC G06F 11/3616; G06F 8/75; G06F 11/3612

(57) ABSTRACT

A computing system operates according to a method including: identifying a code difference set representing a difference in a first code and a second code, wherein the first code corresponds to a first application and the second code corresponds to a second application subsequent to the first application; determining a first performance metric and a second performance metric, wherein the first performance metric is associated with executing the first application and the second performance metric is associated with executing the second application; determining a target code portion based on comparing the first performance metric and the second performance metric, wherein the target code portion is a portion of the code difference set representing an estimated cause for a regression associated with a difference between the first performance metric and the second performance metric; and generating an adjustment task based on the target code portion for addressing the regression.

### BACKGROUND

Computing systems are accessed by users to communicate with each other, share their interests, upload images and videos, create new relationships, etc. For example, social networking services and communication systems can execute on computing systems to enable users to communicate with each other through devices. The computing systems can execute applications or software executables and perform operations on one or more service provider devices, one or more end-user devices, or a combination thereof accordingly.

Service providers often modify or upgrade the applications to provide additional features or to correct issues. However, subsequent versions (e.g., for releases or updates) of the application can sometimes include bugs or regressions (e.g., unwanted behavior, state, or result) that cause the application to function in an unintended manner.

While causes for the bugs or the regressions can be determined by comparing codes associated with the different versions of the application, such regression tests can require large amounts of time and/or resources. As such, there is a need to improve efficiency in managing regressions that occur between software changes.

### BRIEF DESCRIPTION OF THE DRAWINGS

FIG. 1 is block diagram illustrating an overview of a computing system in which some embodiments may operate.

FIG. 2 illustrates an example of a code comparison in accordance with various embodiments.

FIG. 3 illustrates examples of processing results in accordance with various embodiments.

FIG. 4 is a flow chart illustrating a method of operating the computing system of FIG. 1, in accordance with various embodiments.

FIG. 5 is a functional block diagram of the computing system of FIG. 1, in accordance with various embodiments.

FIG. 6 is a block diagram of an example of a computing device, which may represent one or more computing devices or servers described herein, in accordance with various embodiments.

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

Various embodiments are directed to managing regressions (e.g., including regression testing). For example, various embodiments can be directed to automatically identifying or determining problematic portions, automatically generating regression management tasks, and/or automatically generating fixes or adjustments to address the regression based on determining differences between codes and analyzing performance traits associated with applications that correspond to the different codes.

In some embodiments, a computing system can process the regression according to call graphs associated with execution of the applications. For example, the computing system can collect snapshots of stack traces (e.g., reports of contents in the stack for the given moment) across different execution times and/or devices, and use the snapshots to generate call graphs (e.g., representation of flow or movements, such as a sequence of function calls, occurring during an execution of the corresponding application). The computing system can further analyze a difference between the codes associated with the different versions (e.g., the changed code/text between versions, personnel associated with the difference, a type or a category associated with the difference, an amount associated with the difference, etc.). The computing system can generate a task and/or a code adjustment to deal with the regression based on determining a pattern or a connection between the call graphs and the code differences (e.g., using artificial intelligence or machine learning mechanisms).

In some embodiments, the computing system can process the regression according to client-side metrics. For example, the computing system can track metrics associated with performance of the client device (e.g., render time), external influences (e.g., network delay), or a combination thereof for various versions of the application. The computing system can further determine the difference in codes (e.g., a difference in an amount of JavaScript in the code). The computing system analyze the pattern or the connection between the change in the code and the client-side metrics in light of the external influences. Accordingly, the computing system can generate the task and/or the code adjustment to deal with the associated regression.

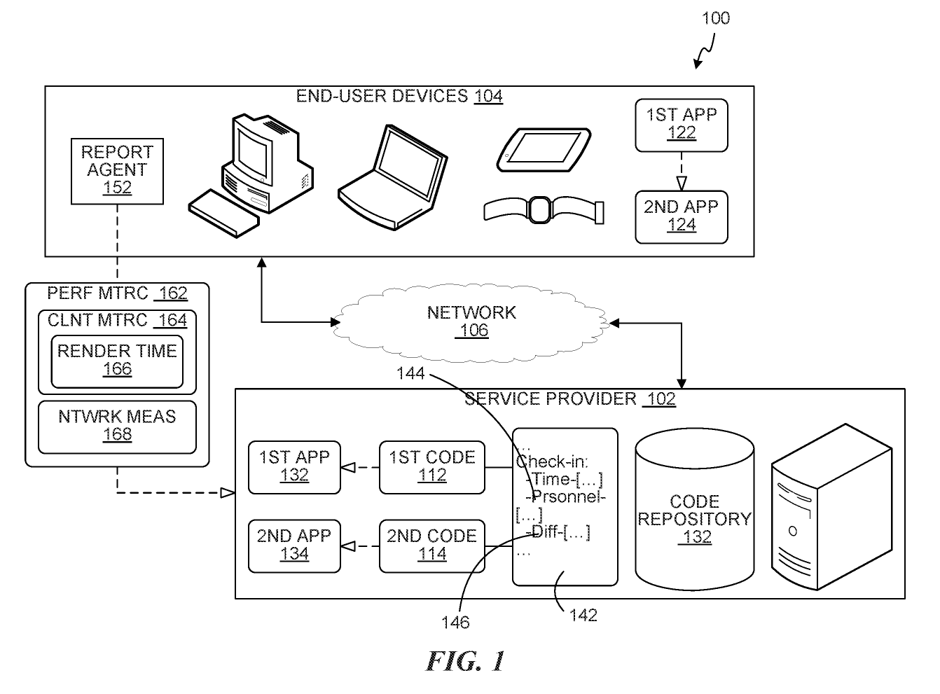

Referring now to the figures, FIG. 1 is block diagram illustrating an overview of a computing system 100 in which some embodiments may operate. The computing system 100 can include a social networking system or a communication system. The computing system 100 can include a service provider 102 (e.g., one or more devices for a social networking service, an internet service provider, or a telecommunications or wireless communications service provider) connecting to and exchanging information with end-user devices 104 through an external network 106. The service provider 102 can use a circuit, a devices, a system, a function, or a combination thereof (e.g., servers, proxies, modems, switches, repeaters, or base stations) configured to manage communication or exchange of data between devices.

The end-user devices 104 can include one or more client computing devices (e.g., a wearable device, a mobile device, a desktop computer, a laptop, etc.). The end-user devices 104 may operate in a networked environment using logical connections to one or more remote computers. The end-user devices 104 can connect to each other, the service provider 102, or a combination thereof. The end-user devices 104 can connect to other devices through the external network 106.

The external network 106 can include wired or wireless networks connecting various devices for communicating or exchanging data. For example, the external network 106 can include local area networks (LAN), wide area networks (WAN), wireless fidelity (WiFi) network, fiber optic networks, cellular network, the Internet, or a combination thereof.

The computing system 100 can include codes (e.g., first code 112 and second code 114) associated with different versions of an application (e.g., a software executable file, such as a first application version 122 and a second application version 124, different versions of a website, etc.). For example, the first application version 122 can be a result of compiling and building the first code 112, and the second application version 124 can be a result of compiling and building the second code 114. The first application version 122 can precede the second application version 124 (e.g., the second application version 124 can be the version that immediately follows the first application version 122).

The computing system 100 can store and track the various codes across versions. For example, the computing system 100 can store the codes in a code repository 132. The code repository 132 can further track details associated with changes that are made to the code. In some embodiments, the code repository 132 can allow one or more users to check the code (e.g., a function, a class, a file, etc.) out, update or adjust the code, check the code back in, etc. The code repository 132 can also determine a code update profile 142 (e.g., a summary, a log, or a report of activities associated with the corresponding code, such as for representing who checked out what code portion at what date/time and/or what changed). For example, the code update profile 142 can include an updating personnel 144 (e.g., a user that checked the code out or made changes to the code, one or more users that own a specific portion of the code, a supervisor or a manager associated with such user, etc.). Also for example, the code update profile 142 can include a script difference 146 representing non-overlapping or mismatching portions of the code between checkouts and/or versions, a characteristic thereof, such as for an amount of difference, a location of the difference, a type of code having the difference, etc. As a more specific example, the script difference 146 can represent a difference in a number or a quantity of JavaScript executions between checkouts and/or versions of the corresponding code. In some embodiments, the computing system 100 can determine the differences between codes (e.g., determine the code update profile 142, the script difference 146, etc.) using a different tool (e.g., a text-comparison software or application).

In some embodiments, the application can include a reporting agent 152 (e.g., a portion of the application) that measures at the end-user devices 104 performance metrics 162 associated with executing the application and further reports the measured values back to the service provider 102. For example, the reporting agent 152 can determine client-side metrics 164 (e.g., render times 166 needed to render or display specific images) and/or external metrics, such as network measures 168 (e.g., latency measurements, error rates, signal strengths, etc.). Also for example, the reporting agent 152 can determine and send back snap-shots of stack content at various times or instances during execution of the application, from various devices, or a combination thereof. The computing system 100 can use the values from the reporting agent 152 to manage the regressions.

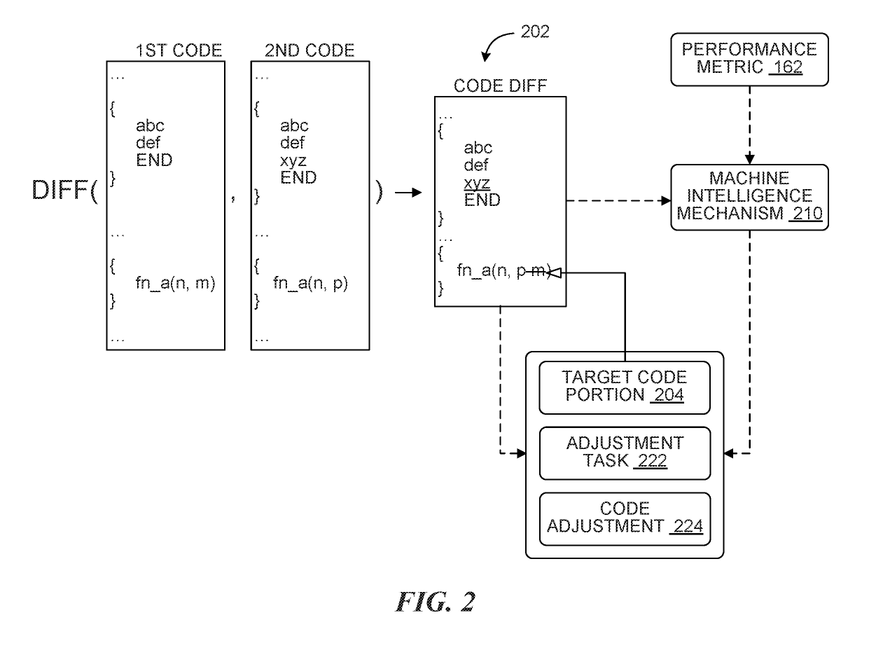

FIG. 2 illustrates an example of a code comparison in accordance with various embodiments. The computing system 100 of FIG. 1 (e.g., the service provider 102 of FIG. 1) can determine one or more differences between codes (e.g., the first code 112 and the second code 114), such as before code check-out event and after code check-in event or across different code versions. For example, the computing system 100 can identify a code difference set 202 representing the differences between the codes based on implementing a text/code comparator (e.g., a PHP parser).

The computing system 100 can analyze the code difference set 202 along with the performance metrics 162 to determine a target code portion 204 representing an estimated cause for the regression associated with the application (e.g., as found in the second application version 124 of FIG. 1). In some embodiments, the computing system 100 can use or implement an intelligence mechanism 210 (e.g., artificial intelligence and/or machine learning functions) to determine the target code portion 204 from within the code difference set 202, such as based on determining one or more patterns between the performance metrics 162, stack information, the code difference set 202, the regression, or a combination thereof.

In some embodiments, the computing system 100 can further generate an adjustment task 222 (e.g., a notification or a work item for managing the regression), a code adjustment 224 (e.g., a fix or an adjustment in the code, such as the second code 114, for managing or eliminating the regression), or a combination thereof associated with the regression. The computing system 100 can generate the adjustment task 222, the code adjustment 224, or a combination thereof based on interacting with the user, implementing the intelligence mechanism 210, or a combination thereof. For example, the computing system 100 can use the adjustment task 222 to notify the user of the target code portion 204 so that the user can generate the code adjustment based on the target code portion 204. Also for example, the computing system 100 can generate the code adjustment 224 autonomously using the intelligence mechanism 210, such as by reverting back to the values/codes in the previous version, by applying an applicable change or fix used in a previous similar regression, etc. The computing system 100 can adjust the portion of the code (e.g., the target code portion 204) responsible for causing the regression with or using the code adjustment 224 to eliminate or minimize the regression.

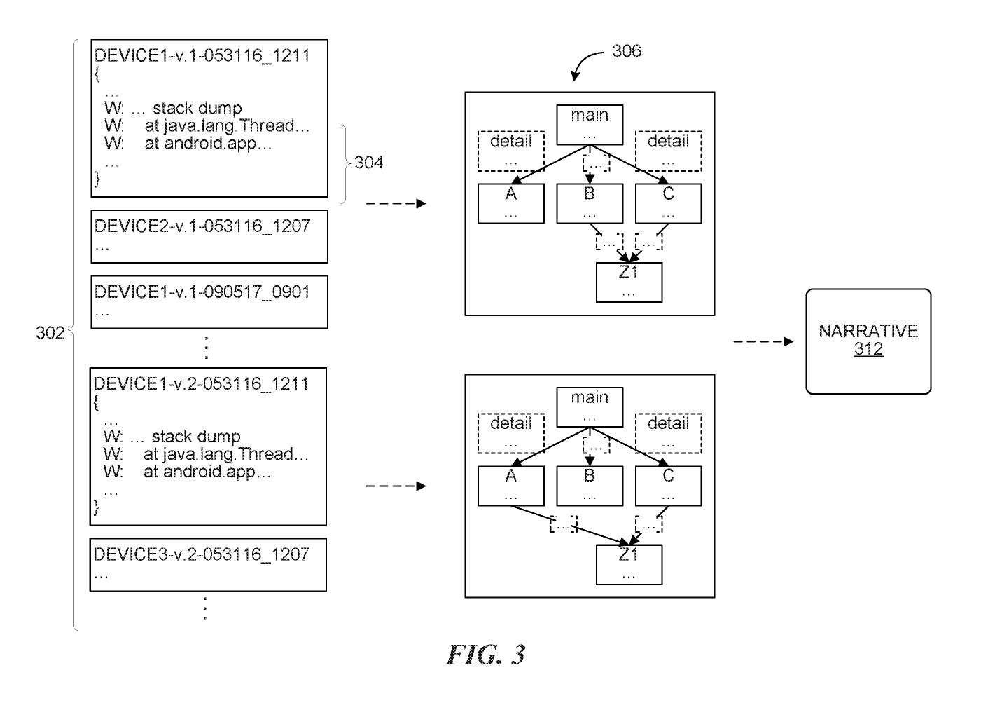

FIG. 3 illustrates examples of processing results in accordance with various embodiments. The computing system 100 of FIG. 1 can generate and utilize processing results, such as snap shots 302, stack traces 304, call graphs 306, or a combination thereof to manage the regression.

In some embodiments, the application can send the snap shots 302 (e.g., as a part of the performance metrics 162) from the end-user devices 104 of FIG. 1 to the service provider 102 of FIG. 1. The snap shots 302 can represent a progress, a state, a value, or a combination thereof associated with execution of the corresponding application. For example, the snap shots 302 can include the stack traces 304 (e.g., a report of stack content captured at that moment based on executing the corresponding application) generated based on executing or running the first application version 122 of FIG. 1, the second application version 124 of FIG. 1, or a combination thereof. The service provider 102 can receive and store the snap shots 302 and/or the stack traces 304 according to the application, the version, the corresponding code, a sending device identification, a received time, or a combination thereof.

In some embodiments, the computing system 100 can generate the call graphs 306 (e.g., representation of flow or movements, such as a sequence of function calls, occurring during an execution of the corresponding application) based on the snap shots 302 and/or the stack traces 304. For example, the computing system 100 can compare and/or aggregate the stack traces 304 according to the versions to build a call graph for each version. The computing system 100 can use the intelligence mechanism 210 of FIG. 2 to generate the call graphs 306.

The computing system 100 can further use the call graphs 306 to generate the adjustment task 222 of FIG. 2, the code adjustment 224 of FIG. 2, or a combination thereof. In some embodiments, the computing system 100 can generate a narrative 312 (e.g., an explanation, a description, or a summary) for the regression, the target code portion 204 of FIG. 2, or a combination thereof. For example, the computing system 100 can interact with the user to receive and record the narrative 312 for the regression, the target code portion 204, corresponding adjustment task and/or corresponding code adjustment, or a combination thereof. Also for example, the computing system 100 can use the intelligence mechanism 210 to generate the narrative 312 based on identifying a similarity or a pattern between context or situation (e.g., data values for the performance metrics 162, the code difference set 202, the stack traces 304, the call graphs 306, the code update profile 142, etc.) for previously entered narratives and the current situation that is being analyzed. Based on a match between the situations, the computing system 100 can generate the narrative 312 as the matching narrative that was previously entered or as a derivative thereof.

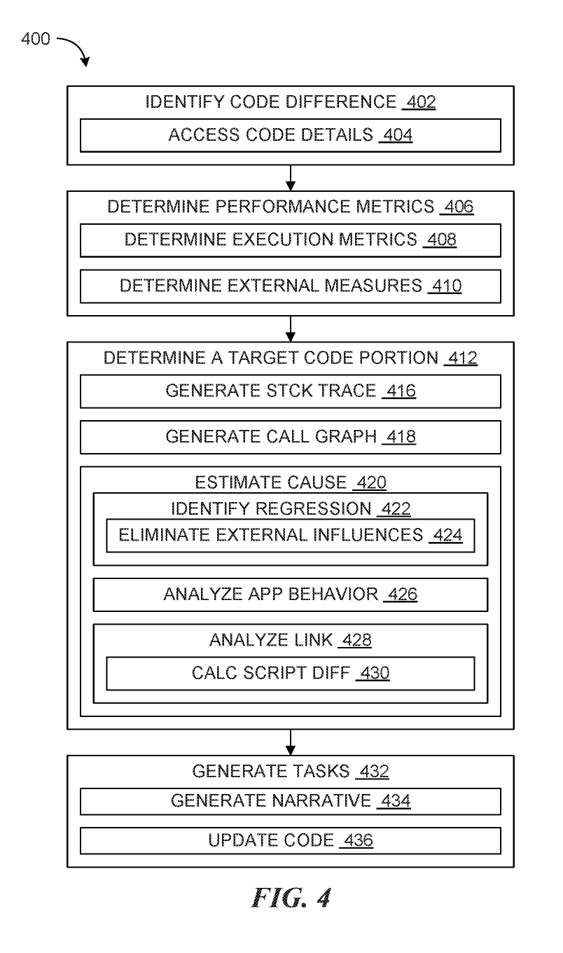

FIG. 4 is a flow chart illustrating a method 400 of operating the computing system 100 of FIG. 1, in accordance with various embodiments. The computing system 100 can manage the regression (e.g., unwanted changes in the application that occur after moving from the first application version 122 of FIG. 1 to the second application version 124 of FIG. 1) based on analyzing a difference between execution of the application corresponding to different versions and a difference between codes (e.g., the first code 112 of FIG. 1 and the second code 114 of FIG. 1) corresponding to the different versions.

At block 402, the computing system 100 (e.g., using one or more devices or processors at the service provider 102 of FIG. 1) can identify differences in codes. The computing system 100 can identify the code difference set 202 of FIG. 2 based on analyzing the first code 112 and the second code 114 in the code repository 132 of FIG. 1. For example, the computing system 100 can use text or code comparison applications, such as PHP parser, to compare the first code 112 and the second code 114 and identify the code difference set 202 as the difference between the two codes.

At block 404, the computing system 100 can access details or notes associated with the code difference set 202. For example, the computing system 100 can access the database or the records in the code repository 132 and identify the code update profile 142 of FIG. 1 associated with each code sections in the code difference set 202. Accordingly, the computing system 100 can access information representing the updating personnel 144 of FIG. 1, an amount of update (e.g., a change in a number of lines or commands), a description of changed code portion, user's notes, or a combination thereof associated with the code portions identified in the code difference set 202.

At block 406, the computing system 100 can determine performance metrics associated with the different versions of the application. The computing system 100 can store and process the performance metrics 162 of FIG. 1 (e.g., the client-side metrics 164 of FIG. 1, such as the render times 166 of FIG. 1, or the snap shots 302 of FIG. 1, the network measures 168 of FIG. 1, etc.) sent from the client devices to the service provider 102 using the reporting agent 152 of FIG. 1. The computing system 100 can store and process the performance metrics 162 associated with executing the different versions of the application (e.g., the first application version 122 and the second application version 124).

For example, the computing system 100 can determine execution metrics (e.g., the client-side metrics 164 and/or the snap shots 302 including the stack traces 304 of FIG. 3) at block 408. In some embodiments, the reporting agent 152 can measure the render times 166 at one or more points in executing the application (e.g., the first application version 122 and/or the second application version 124) and report the render times 166 to the service provider 102. The computing system 100 (e.g., the service provider 102) can receive the client-side metrics 164 and/or the snap shots 302 from various devices implementing the application. The computing system 100 can receive the client-side metrics 164 and/or the snap shots 302 associated with execution of the application at different times, locations, contexts, etc. The computing system 100 can store the received information and group them according to the version and/or other contextual parameters, such as device operating system, device identification or manufacturer, concurrently executed applications, geographic locations of the device, etc.

Also for example, the computing system 100 can determine external metrics (e.g., the network measures 168) associated with executions of the application at block 410. In some embodiments, the computing system 100 can measure or calculate the network delay or a communication latency, such as a difference between a send time and a receive time, at different times (e.g., at regular intervals, at random times, or for each exchanged message).

At block 412, the computing system 100 can determine the target code portion 204 likely causing the regression. The computing system 100 can analyze the various differences and behaviors (e.g., the code difference set 202, the performance metrics 162, the client-side metrics 164, the network measures 168, the snap shots 302, the stack traces 304, or a combination thereof) associated with the different versions of the application (e.g., the first application version 122 and/or the second application version 124) and generate the target code portion 204.

At block 416, the computing system 100 can determine stack traces (e.g., the stack traces 304) based on the performance metrics 162 and/or the snap shots 302 therein. The computing system 100 can identify or extract the stack traces 304 from the snap shots 302 captured based on executing the applications on various devices, at various times, under various contexts or situations, or a combination thereof. For example, the computing system 100 can identify or extract the stack traces 304 based on a specific portion within the snap shots 302 and/or the performance metrics 162, based on a specific identifier or a header, or a combination thereof.

The computing system 100 can further group the stack traces 304 according various parameters. For example, the computing system 100 can group the stack traces 304 according to the version of the application (e.g., the first application version 122 or the second application version 124) used to generate the stack traces 304. Also for example, the computing system 100 can group the stack traces 304 according to other contextual parameters, such as a device identifier or manufacturer, a device capacity or capability, a time of execution, a device location at the time of execution, an operating system used the device, a driver associated with the executing client device or a portion therein, other concurrently executed applications or functions, etc.

At block 418, the computing system 100 can generate call graphs (e.g., the call graphs 306) based on the stack traces 304. The computing system 100 can generate the call graphs 306 based on the stack traces 304 that correspond to the execution of different versions of the application executed at various times, on various client devices, or a combination thereof. The computing system 100 can further generate the call graphs 306 that each correspond to a specific version of the application and/or specific combination of the contextual parameters. For example, the computing system 100 can generate a first call graph associated with the first application version 122 and a second call graph associated with the second application version 124. Also for example, the computing system 100 can generate a call graph for a specific combination of the contextual parameters, such as for representing executions of a version of the applications on a specific device running a specific operating system, using a specific driver, simultaneously executing a specific function or command, etc.

The computing system 100 can generate the call graphs 306 based on aggregating the stack traces 304 that correspond to the targeted condition (e.g., the version, the specific combination of the contextual parameters, etc.). The computing system 100 can generate the call graphs 306 based on aggregating the unique sequence of functions or execution markers and/or unique inputs or conditions in transitioning between stack values or states, and then connecting the common markers or states.

In some embodiments, the computing system 100 can use the intelligence mechanism 210 to generate the call graphs 306 (e.g., based on using machine learning to identify clusters that represent unique function calls or states, and relationship or connection between clusters that represent transition between the function calls or states). In some embodiments, the computing system 100 can interact with a user to generate the call graphs 306. For example, the computing system 100 can present a model or a set of connected clusters (e.g., as a result of using the intelligence mechanism 210, such as unsupervised learning) and corresponding stack values to the user, and the user can name or map the clusters to specific functions and/or adjust the connection between the clusters. Also for example, the computing system 100 can receive a set of functions or categories associated with specific stack values (e.g., training samples that describe a known set of stack values and function calls, such as for in-house testing results), which can be used to implement the intelligence mechanism 210 (e.g., such as for supervised learning).

At block 420, the computing system 100 can estimate a cause for the regression based on analyzing results of executing different versions of the application along with the changes in the code for the different versions. For example, the computing system 100 can estimate the cause based on identifying the regression, analyzing details regarding execution of the applications, analyzing a link between the regression and the behavioral or flow details, or a combination thereof.

At block 422, the computing system 100 can identify one or more regressions that may have occurred in transitioning between versions of the application. The computing system 100 can identify the regression based on comparing the performance metrics 162 across the first application version 122 and the second application version 124. For example, the computing system 100 can calculate a difference in the client-side metrics 164, such as the render times 166, error or failure counts, reloads or repeated inputs within a threshold time, etc., between the first application version 122 and the second application version 124.

The computing system 100 can further identify or qualify the differences in the performance metrics 162 to identify the one or more regressions. For example, the computing system 100 can interact with the user to identify specific differences (e.g., a failure or error state or message, an increase in flowing from one state or function to another, an increase in execution time for a function, an increase in the render times 166, a previously absent state or behavior, etc.) as regressions. Also for example, the computing system 100 can use thresholds, ranges, limits, etc. to qualify corresponding metrics or changes as regressions. Also for example, the computing system 100 can use the intelligence mechanism 210 (e.g., supervised learning system including training data to identify regressions) to analyze the differences and identify the regressions.

In some embodiments, the computing system 100 can eliminate external influences to further clarify estimations of the regressions, as represented at block 424. The computing system 100 can use the network measures 168 to eliminate the external influences. Accordingly, the computing system 100 can eliminate any errors or performance degradations caused by factors external to workings or flows of the application (e.g., operations directly linked to or caused by the corresponding code).

For example, the computing system 100 can remove data samples that coincide with or are concurrent with the network measures 168 (e.g., network latencies or delays) that satisfy or exceed a threshold (e.g., such as for network outages or excessive delays). Also for example, the computing system 100 can reduce the client-side metrics 164 by the network measures 168 or other external measures at the time (e.g., such as for normalizing data samples). Accordingly, the difference in the client-side metrics 164 across versions can be without influences from the network measures 168 or other external influences.

At block 426, the computing system 100 can analyze behaviors or flows that occur within the application or executions thereof. The computing system 100 can analyze the behaviors or flows based on comparing the stack content. For example, the computing system 100 can analyze based on comparing the call graphs 306 of the different versions of the application. Based on the comparison, the computing system 100 can identify outliers or non-overlapping portions (e.g., a new state or function, a new transition, a new output or input value, etc.) in the call graphs 306 between the compared versions.

In some embodiments, the computing system 100 can compare the call graphs 306 based on identifying different states, functions, or value combinations as nodes or clusters. The computing system 100 can compare the nodes (e.g., using netlists) across the call graphs 306. The computing system 100 can further compare transitions between nodes (e.g., sequences or orders, value updates, such as for inputs or outputs, associated with the change in the nodes, etc.) across the call graphs 306.

At block 428, the computing system 100 can analyze a link between the identified regressions, the analyzed behaviors or flows, changes in the code, or a combination thereof. The computing system 100 can analyze the link based on determining a relationship or a link (e.g., such as concurrent occurrence or based on an identifiable pattern or sequence) between the outliers in the call graphs 306 and the identified regression. The computing system 100 can further analyze the link based on determining a relationship between the code (e.g., the second code 114) and the identified regression (e.g., the difference in the performance metrics 162) and/or the outliers in the call graphs 306.

In some embodiments, the computing system 100 can analyze the link based on interacting with the user to determine connections or relationships (e.g., the link) between portions of the code (e.g., for portions within the code difference set 220 or within the second code 114) and specific stack values, portions of the call graphs 306, specific behaviors or outcomes of the application, the performance metrics 162, or a combination thereof. The computing system 100 can use the user-determined connections or relationships to determine connections or relationships that match the identified regression.

In some embodiments, the computing system 100 can analyze the link based on receiving a training set of data representing the user-determined connections or relationships. The computing system 100 can implement the intelligence mechanism 210 and generate a model according to the training set (e.g., for supervised learning), and apply the model to the current set of data to determine the link corresponding to the identified regression.

In some embodiments, the computing system 100 can implement the intelligence mechanism 210 with the various data discussed above as inputs. The computing system 100 can implement the intelligence mechanism 210 (e.g., pattern recognition or unsupervised learning) to identify clusters that have a connection or an overlap between the identified regression and the code differences and/or the outliers in the call graphs 306.

Through the analysis, the computing system 100 can determine the target code portion 204 as the portion of the code within the code difference set 202 that is linked to the regression and/or the outlier in the call graphs 306. Accordingly, the computing system 100 can determine the target code portion 204 and/or the outlier in the call graphs 306 as an estimate of the cause for the identified regression.

In some embodiments, the computing system 100 can further analyze additional information, such as the code update profile 142. For example, the computing system 100 can consider the updating personnel 144 (e.g., for considering computer models representing common mistakes or coding behavior associated with the user that adjusted the code), the amount of change (e.g., a change in the number of lines or commands), a type of function or command that was changed, a user comment in or about the code, etc. in analyzing the cause for the identified regression.

For example, the computing system 100 can identify a difference in specific types of codes, such as illustrated at block 430. In some embodiments, the computing system 100 can analyze the render times 166 along with the script difference 146 (e.g., a difference in a number or a quantity of JavaScript code) associated with the code difference set 202. The computing system 100 can match the change in the render times according to proportionate changes in the script difference 146, such as by ordering or ranking both the render times and the script differences 146. The computing system 100 can determine the target code portion 204 as portions of code within the code difference set 202 that correspond to an amount of change in the corresponding render time (e.g., for increases in the render time that exceed an allowable threshold). In some embodiments, the computing system 100 can use functions or other applications to determine the target code portion 204.

In determining the target code portion 204, the computing system 100 can use the normalized samples or data (e.g., according to the normalization process discussed above) to reduce or eliminate the external influences, such as the network measures 168, on the performance metrics 162, such as for the render times 166. Accordingly, the computing system 100 can focus on the effects of the code in determining the target code portion 204.

At block 432, the computing system 100 can generate tasks based on the above described analysis for managing the identified regression. The computing system 100 can generate the adjustment task 222 (e.g., a communication to a user, a schedule or a task event in a calendar, etc.) for addressing the regression. For example, the computing system 100 can generate the adjustment task 222 to notify the user of the identified regression and/or to assist the user in regression management by notifying the target code portion 204, the outlier in the call graphs 306, or a combination thereof that is likely causing the regression. Also for example, the computing system 100 can autonomously update or fix the code to eliminate or minimize the regression based on the target code portion 204, the outlier in the call graphs 306, or a combination thereof.

At block 434, the computing system 100 can generate narratives (e.g., the narratives 312) associated with the regressions. The computing system 100 can generate the narratives 312 corresponding to the identified regressions (e.g., the difference between the performance metrics 162 across the versions). In some embodiments, the computing system 100 can interact with the user to receive explanations, notes, descriptions, etc. associated with the identified regressions. The computing system 100 can further use the user-provided information and the corresponding regression and/or portions of code as a verified sample or training data for the intelligence mechanism 210. In some embodiments, the computing system 100 can generate the narratives 312 based on matching the current situation (e.g., the code difference set 202, the target code portion 204, the stack traces 304, the regression, etc.) with a previous or known situation. The computing system 100 can generate the narrative for the current situation as the previous narrative used for a similar or a matching situation.

Further, in some embodiments, the computing system 100 can generate the adjustment task 222 or the narrative 312 for a specific user, such as the updating personnel 144 associated with the target code portion 204. For example, the computing system 100 can notify the updating personnel 144 that is responsible for or owns the code portion. Also for example, the computing system 100 can notify the updating personnel 144 that caused the change in the target code portion 204 or previously worked on the corresponding portion of the code.

At block 436, the computing system 100 can manage updates to the code (e.g., the second code 114) for reducing or removing the regression. For example, the computing system 100 can track and update the adjustment task 222 according to updates to the second code 114 made by a user (e.g., according to transactions for the second code 114 through the code repository 132). The computing system 100 can further interact with the user to update the second code 114, such as by checking the second code 114 out to the user and/or notifying the user (e.g., by highlighting or specifically displaying) of the target code portion 204.

In some embodiments, the computing system 100 can autonomously update the second code 114. For example, the computing system 100 can eliminate the target code portion 204 or revert the target code portion 204 back to the corresponding portion in the previous version (e.g., the first code 112). Also for example, the computing system 100 can implement the intelligence mechanism 210 and adjust the target code portion 204 according to a pattern in other portions of the first code 112 and/or the second code 114, one or more previous updates or adjustments (e.g., for matching or similar situation or contexts according to the various data parameters discussed above), or a combination thereof.

The adjustment task 222 and the target code portion 204 autonomously generated based on the performance metric 162 provides increased efficiency in managing regressions. Because of the massive amounts of code required for most applications, it is often difficult for developers to debug or troubleshoot code for most of today's applications. As such, a machine-aided process for catching the regressions, identifying potential causes, and directing the developer to specific portions of the code likely linked to the potential causes can all reduce the amount of time and effort required by the developer to improve the applications. Further, automatically collecting, processing, and providing the track traces 304 and/or the call graphs 306 can provide the data necessary for the debugging process, thereby eliminating the need to recreate such data under test conditions. For more advanced systems, the computing system 100 can autonomously adjust the code or provide suggestions (e.g., previous fixes or how the code looked before the problematic adjustments), which can further reduce time and effort of the developer.

While processes or boxes are presented in a given order, alternative embodiments may perform routines having steps, or employ systems having boxes, in a different order, and some processes or boxes may be deleted, moved, added, subdivided, combined, and/or modified to provide alternative or subcombinations. In addition, while processes or boxes are at times shown as being performed in series, these processes or boxes may instead be performed in parallel, or may be performed at different times. Each of these processes or boxes may be implemented in a variety of different ways. When a process or step is “based on” a value or a computation, the process or step should be interpreted as based at least on that value or that computation.

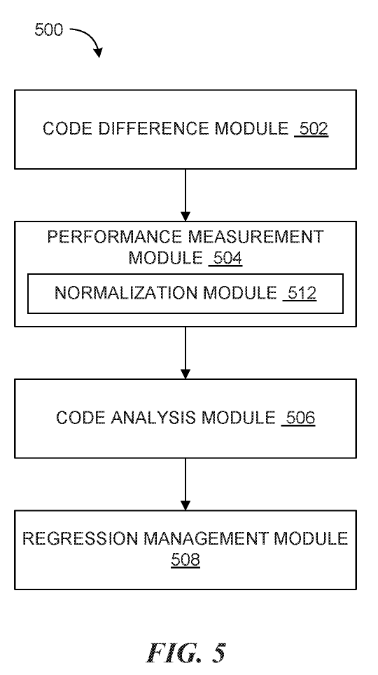

FIG. 5 is a functional block diagram of the computing system 100 of FIG. 1, in accordance with various embodiments. The computing system 100 can include a code difference module 502, a performance measurement module 504, a code analysis module 506, a regression management module 508, or a combination thereof. The code difference module 502, the performance measurement module 504, the code analysis module 506, the regression management module 508, or a combination thereof can be coupled to each other, such as using hardware connections (e.g., wires or wireless connections) or software connects (e.g., function calls, interrupts, input-output relationships, address or value settings, etc.).

The code difference module 502 can be configured to determine the difference between versions of the code (e.g., between the first code 112 of FIG. 1 and the second code 114 of FIG. 1, in the code before check-out and after check-in events relative to the code repository 132 of FIG. 1 or other code management systems, etc.). The code difference module 502 can be configured to implement function of the code repository 132 (e.g., for comparison between check-out and check-in events, for generating or updating the code update profile 142 of FIG. 1, etc.) and/or the processes discussed above for block 402 and/or block 404 of FIG. 4. For example, the code difference module 502 can identify the code difference set 202 of FIG. 2 and/or identify the code update profile 142 associated with each code sections in the code difference set 202.

The performance measurement module 504 can be configured to determine various metrics or measures (e.g., internal and/or external to the operations for the application) associated with execution of the different versions of the application. The performance measurement module 504 can be configured to implement the processes discussed above for one or more of blocks 406-410 of FIG. 4. For example, the performance measurement module 504 can determine and process the performance metrics 162 of FIG. 1, the snap shots 302 of FIG. 1, the environmental or external measures or parameters, etc.

The performance measurement module 504 can include a normalization module 512. The normalization module 512 can be configured to process the metrics or measures to normalize the data. The normalization module 512 can be configured to implement the processes discussed above for block 424 of FIG. 4. For example, the normalization module 512 can remove the external influences from the client-side metrics 164 and isolate the effects from the codes and the actual flow or operations of the application.

The code analysis module 506 can be configured to estimate causes for regressions (e.g., as evidenced or shown in the metrics or measures). The code analysis module 506 can be configured to implement the processes discussed above for one or more of blocks 412-430 of FIG. 4. For example, the code analysis module 506 can analyze the differences and behaviors, determine and analyze the stack traces 304, generate the call graphs 306, identify regressions, identify a link between the regression, behavior, and/or code, or a combination thereof. Accordingly the code analysis module 506 can determine the target code portion 204 and/or the outlier in the call graphs 306 as estimated causes for the regressions.

The regression management module 508 can be configured to coordinate code changes or adjustments to reduce the regressions. The regression management module 508 can be configured to implement the processes discussed above for one or more of blocks 432-436 of FIG. 4. For example, the regression management module 508 can generate the adjustment task 222 of FIG. 2, the code adjustment 224 of FIG. 2, or a combination thereof.

One or more of the modules discussed above can be dedicated hardware circuitry or accelerator, a configuration of one or more processors, a configuration of data within memory, or a combination thereof. Also one or more of the modules discussed above, can be software code or instructions that can be stored in memory, implemented using one or more processors, or a combination thereof. For example, each module can be a set of computer-executable instructions corresponding to a function or a routine. The computing system 100 (e.g., for one or more devices at the service provider 102 of FIG. 1) can include the one or more processors configured to implement (e.g., such as by loading or accessing) the instructions corresponding to the modules discussed above. The computing system 100 can use the one or more processors to implement the method 400 of FIG. 4 by implementing the instructions corresponding to the modules.

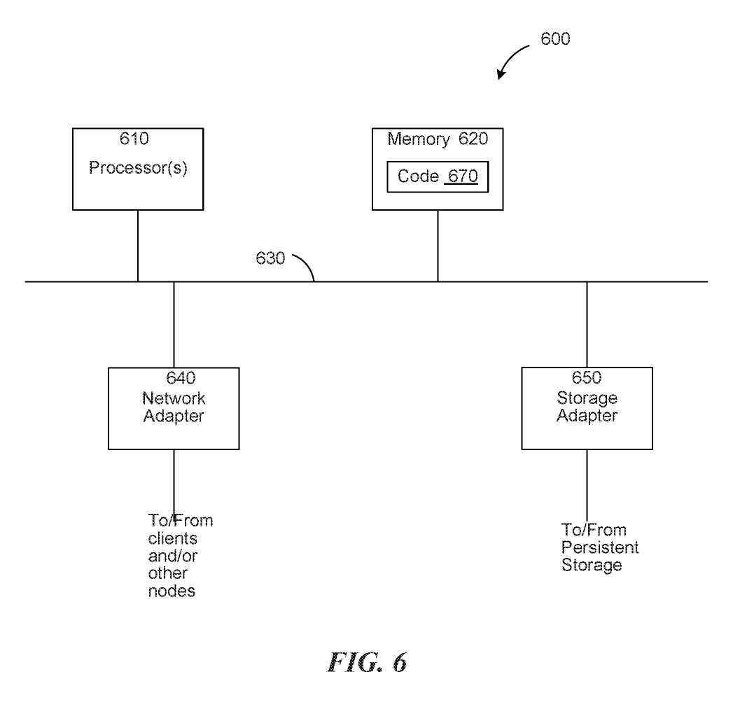

FIG. 6 is a block diagram of an example of a computing device 600, which may represent one or more communicating device or server described herein, in accordance with various embodiments. The computing device 600 can include one or more computing devices that implement the computing system 100 of FIG. 1. The computing device 600 can execute at least part of the method 400 of FIG. 4. The computing device 600 includes one or more processors 610 and memory 620 coupled to an interconnect 630. The interconnect 630 is an abstraction that represents any one or more separate physical buses, point-to-point connections, or both connected by appropriate bridges, adapters, or controllers. The interconnect 630, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”. The interconnect 630 can also include wireless connection or communications between components.

The processor(s) 610 is/are the central processing unit (CPU) of the computing device 600 and thus controls the overall operation of the computing device 600. In certain embodiments, the processor(s) 610 accomplishes this by executing software or firmware stored in memory 620. The processor(s) 610 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 620 is or includes the main memory of the computing device 600. The memory 620 represents any form of random access memory (RAM), read-only memory (ROM), flash memory, or the like, or a combination of such devices. In use, the memory 620 may contain a code 670 containing instructions according to the operation of at least a portion of the computing system 100 or the method 400 disclosed herein.

Also connected to the processor(s) 610 through the interconnect 630 are a network adapter 640 and a storage adapter 650. The network adapter 640 provides the computing device 600 with the ability to communicate with remote devices, over a network and may be, for example, an Ethernet adapter, Fibre Channel adapter, or a wireless modem. The network adapter 640 may also provide the computing device 600 with the ability to communicate with other computers. The storage adapter 650 enables the computing device 600 to access a persistent storage, and may be, for example, a Fibre Channel adapter or SCSI adapter.

The code 670 stored in memory 620 may be implemented as software and/or firmware to program the processor(s) 610 to carry out actions described above. In certain embodiments, such software or firmware may be initially provided to the computing device 600 by downloading it from a remote system through the computing device 600 (e.g., via network adapter 640).

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; and/or optical storage media; flash memory devices), etc.

The term “logic,” as used herein, can include, for example, programmable circuitry programmed with specific software and/or firmware, special-purpose hardwired circuitry, or a combination thereof.

Some embodiments of the disclosure have other aspects, elements, features, and steps in addition to or in place of what is described above. These potential additions and replacements are described throughout the rest of the specification. Reference in this specification to “various embodiments” or “some embodiments” means that a particular feature, structure, or characteristic described in connection with the embodiment is included in at least one embodiment of the disclosure. Alternative embodiments (e.g., referenced as “other embodiments”) are not mutually exclusive of other embodiments. Moreover, various features are described which may be exhibited by some embodiments and not by others. Similarly, various requirements are described which may be requirements for some embodiments but not other embodiments. Reference in this specification to where a result of an action is “based on” another element or feature means that the result produced by the action can change depending at least on the nature of the other element or feature.

What is claimed is:

1. A computer-implemented method, comprising:
identifying a code difference set representing a difference in a first code and a second code, wherein the first code corresponds to a first application and the second code corresponds to a second application subsequent to the first application;
determining a first performance metric and a second performance metric, wherein the first performance metric is associated with executing the first application and the second performance metric is associated with executing the second application;
using one or more processors, determining a target code portion based on comparing the first performance metric and the second performance metric, wherein the target code portion is a portion of the code difference set representing an estimated cause for a regression associated with a difference between the first performance metric and the second performance metric; and
generating an adjustment task based on the target code portion for addressing the regression.

2. The computer-implemented method of claim 1, wherein determining the target code portion includes:
generating a first call graph associated with the first application;
generating a second call graph associated with the second application; and
determining the target code portion based on comparing the first call graph and the second call graph.

3. The computer-implemented method of claim 2, wherein generating the first call graph includes:
determining a stack trace based on executing the first application; and
generating the first call graph based on the stack trace.

4. The computer-implemented method of claim 3, wherein generating the first call graph includes generating the first call graph based on a set of stack traces corresponding to execution of the first application executed at various times, on various client devices, or a combination thereof.

5. The computer-implemented method of claim 1, wherein:
determining the first performance metric and the second performance metric includes determining the first performance metric and the second performance metric corresponding to one or more client side metrics; and
generating the adjustment task includes generating a narrative corresponding to a difference between the first performance metric and the second performance metric.

6. The computer-implemented method of claim 5, wherein generating the narrative includes generating the narrative based on implementing a machine learning mechanism.

7. The computer-implemented method of claim 5, wherein:
determining the first performance metric and the second performance metric includes determining render times for the first application and the second application; and
determining the target code portion includes:
calculating a difference in a script quantity across codes associated with the code difference set, and
determining the target code portion corresponding to a change in the render times based on the difference in the script quantity.

8. The computer-implemented method of claim 7, wherein:
determining the first performance metric and the second performance metric includes determining network measures associated with executions of the first application and the second application; and
determining the target code portion includes distinguishing the render times corresponding to the script quantity difference from effects corresponding to the network measures.

9. The computer-implemented method of claim 1, further comprising updating the second code to reduce the regression.

10. The computer-implemented method of claim 9, wherein updating the second code includes updating the second code based on implementing a machine intelligence mechanism.

11. The computer-implemented method of claim 1, wherein:
identifying the code difference set includes identifying a code update profile representing an updating personnel, an amount of update, a description of changed code portion, or a combination thereof; and
determining the target code portion includes determining the target code portion based on the code update profile.

12. The computer-implemented method of claim 11, wherein generating the adjustment task includes generating the adjustment task for the updating personnel associated with the target code portion.

13. A computer readable data storage memory storing computer-executable instructions that, when executed by a computing system, cause the computing system to perform a computer-implemented method, the instructions comprising:
instructions for identifying a code difference set representing a difference in a first code and a second code, wherein the first code corresponds to a first application and the second code corresponds to a second application subsequent to the first application;
instructions for determining a first performance metric and a second performance metric, wherein the first performance metric is associated with executing the first application and the second performance metric is associated with executing the second application;
instructions for determining a target code portion based on comparing the first performance metric and the second performance metric, wherein the target code portion is a portion of the code difference set representing an estimated cause for a regression associated with a difference between the first performance metric and the second performance metric; and
instructions for generating an adjustment task based on the target code portion for addressing the regression.

14. The computer readable data storage memory of claim 13, wherein instructions for determining the target code portion includes:
instructions for generating a first call graph associated with the first application;
instructions for generating a second call graph associated with the second application; and
instructions for determining the target code portion based on comparing the first call graph and the second call graph.

15. The computer readable data storage memory of claim 14, wherein instructions for generating the first call graph includes:
instructions for determining a stack trace based on executing the first application; and
instructions for generating the first call graph based on the stack trace.

16. The computer readable data storage memory of claim 15, wherein instructions for generating the first call graph includes instructions for generating the first call graph based on a set of stack traces corresponding to execution of the first application executed at various times, on various client devices, or a combination thereof.

17. The computer readable data storage memory of claim 13, wherein:
instructions for determining the first performance metric and the second performance metric includes instructions for determining the first performance metric and the second performance metric corresponding to one or more client side metrics; and
instructions for generating the adjustment task includes instructions for generating a narrative corresponding to a difference between the first performance metric and the second performance metric.

18. The computer readable data storage memory of claim 17, wherein instructions for generating the narrative includes instructions for generating the narrative based on implementing a machine intelligence mechanism.

19. The computer readable data storage memory of claim 17, wherein:
instructions for determining the first performance metric and the second performance metric includes instructions for determining render times for the first application and the second application; and
instructions for determining the target code portion includes:
instructions for calculating a difference in a script quantity across codes associated with the code difference set, and
instructions for determining the target code portion corresponding to a change in the render times based on the difference in the script quantity.

20. The computer readable data storage memory of claim 19, wherein:
instructions for determining the first performance metric and the second performance metric includes instructions for determining network measures associated with executions of the first application and the second application; and
instructions for determining the target code portion includes instructions for distinguishing the render times corresponding to the script quantity difference from effects corresponding to the network measures.
